(19) United States
(12) Patent Application Publication
(10) Pub. No.: US 2014/0132853 A1
(43) Pub. Date: May 15, 2014

(54) CAPACITIVE SENSING STRUCTURE

(71) Applicant: SONIX Technology Co., Ltd., Hsinchu (TW)

(72) Inventor: Chien-Liang Lin, Hsinchu City (TW)

(73) Assignee: SONIX Technology Co., Ltd., Hsinchu (TW)

(21) Appl. No.: 14/044,878

(22) Filed: Oct. 3, 2013

(30) Foreign Application Priority Data
Nov. 12, 2012 (CN) 201220594988.5

(51) Int. Cl. G06F 3/044

(52) U.S. Cl. CPC G06F 3/044
USPC 349/12

(57) ABSTRACT

A capacitive sensing structure is disclosed. The capacitive sensing structure includes a substrate and a plurality of touch units. Each of the touch units includes a first electrode and a second electrode. The first electrode is disposed over a surface of the substrate, and a patterned groove is formed in the first electrode. The patterned groove penetrates the first electrode to form an opening. The second electrode is disposed in the patterned groove and extended out of the first electrode from the opening of the patterned groove. The first electrode is electrically disconnected from the second electrode.

### CROSS-REFERENCE TO RELATED APPLICATION

This application claims the priority benefit of China application serial no. 201220594988.5, filed on Nov. 12, 2012. The entirety of the above-mentioned patent application is hereby incorporated by reference herein and made a part of this specification.

### BACKGROUND OF THE INVENTION

1. Field of the Invention

The present invention generally relates to a sensing structure, and more particularly, to a capacitive sensing structure.

2. Description of Related Art

Along with the development of technologies, touch devices (for example, touch panels and touch pads) offering touch functions have gradually replaced the conventional input devices (for example, keyboards and mouses). Existing touch devices can be generally categorized into capacitive touch devices and resistive touch devices. Among all types of touch devices, capacitive touch device has attracted more attention due to its multi-touch characteristic.

The sensing structure of a capacitive touch device can be categorized as a single-layer electrode structure or a double-layer electrode structure according to the disposition of electrodes. In the double-layer electrode structure, two electrodes are respectively disposed in different conductive layers in a stacked manner, while in the single-layer electrode structure, two electrodes are disposed in the same conductive layer.

Compared to the double-layer electrode structure, the single-layer electrode structure consumes a lower manufacturing cost to a capacitive touch device. Additionally, in regard to a conventional single-layer electrode structure, a capacitive touch device needs to sense each electrode in the conventional single-layer electrode structure. Thus, in the capacitive touch device with the conventional single-layer electrode structure, a sensing channel has to be disposed with respect to each electrode, which causes the circuit layout of the capacitive touch device to be very complicated.

### SUMMARY OF THE INVENTION

Accordingly, the present invention is directed to a capacitive sensing structure, in which the touch units have a single-layer electrode structure, and the circuit layout of a capacitive touch device is simplified.

The present invention provides a capacitive sensing structure including a substrate and a plurality of touch units. Each of the touch units includes a first electrode and a second electrode. The first electrode is disposed over a surface of the substrate, and a patterned groove is formed in the first electrode. The patterned groove penetrates the first electrode to form an opening. The second electrode is disposed in the patterned groove and extended out of the first electrode from the opening of the patterned groove. The first electrode is electrically disconnected from the second electrode.

According to an embodiment of the present invention, the capacitive sensing structure further includes a first touch circuit. The first touch circuit is formed by a 1^{st} touch unit to an N^{th} touch unit among the touch units, and the second electrodes in the 1^{st} touch unit to the N^{th} touch unit are electrically connected, where N is a positive integer.

According to an embodiment of the present invention, the capacitive sensing structure further includes a second touch circuit. The second touch circuit is formed by a (N+1)^{th} touch unit to a 2N^{th} touch unit among the touch units. The second electrodes in the (N+1)^{th} touch unit to the 2N^{th} touch unit are electrically connected, and the first electrode in the i^{th} touch unit is electrically connected to the first electrode in the (i+N)^{th} touch unit, where i is an integer, and 1≦i≦N.

The present invention provides a capacitive sensing structure including a substrate and a plurality of touch units. Each of the touch units includes a first electrode and a second electrode. The first electrode is disposed over a surface of the substrate, and a groove is formed penetrating the first electrode. The second electrode is disposed in the groove, and the first electrode is electrically disconnected from the second electrode. Each of the first electrode and the second electrode is capable of transmitting a signal to a corresponding processor.

As described above, in a capacitive sensing structure provided by the present invention, the touch units have a single-layer electrode structure. Besides, according to the present invention, the second electrodes in a touch circuits are electrically connected, and the first electrodes located at the corresponding positions in the touch circuits are also electrically connected. Thereby, in a capacitive touch device having the capacitive sensing structure provided by the present invention, the amount of sensing channels is reduced, and accordingly the circuit layout of the capacitive touch device is simplified.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a capacitive sensing structure according to an embodiment of the present invention.

FIG. 2A is a diagram of a touch unit according to an embodiment of the present invention.

FIGS. 2B-2D are diagrams of a touch unit according to other embodiments of the present invention.

FIG. 3 is a diagram of a capacitive sensing structure according to another embodiment of the present invention.

FIG. 4 is a diagram of a capacitive sensing structure according to yet another embodiment of the present invention.

FIG. 5 is a diagram of a capacitive sensing structure according to still another embodiment of the present invention.

FIG. 6 is a diagram of a capacitive sensing structure according to yet still another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

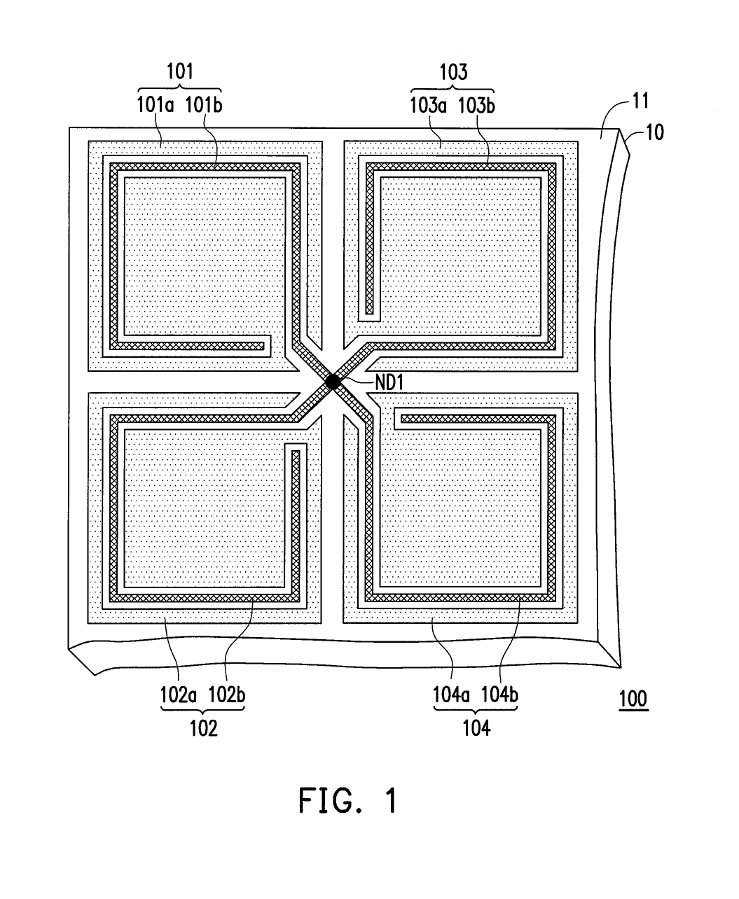

FIG. 1 is a diagram of a capacitive sensing structure according to an embodiment of the present invention. Referring to FIG. 1, the capacitive sensing structure 100 includes a substrate 10 and a plurality of touch units 101-104. The touch units 101-104 are disposed over a surface 11 of the substrate 10 to form a single-layer electrode structure. In other words, the touch units 101-104 are disposed in the same conductive layer.

The touch unit 101 includes a first electrode 101a and a second electrode 101b, and the touch unit 102 includes a first electrode 102a and a second electrode 102b. Similarly, the touch unit 103 includes a first electrode 103a and a second electrode 103b, and the touch unit 104 includes a first electrode 104a and a second electrode 104b. In other words, each touch unit includes a first electrode and a second electrode, and the two electrodes in each touch unit have the same layout or similar layouts.

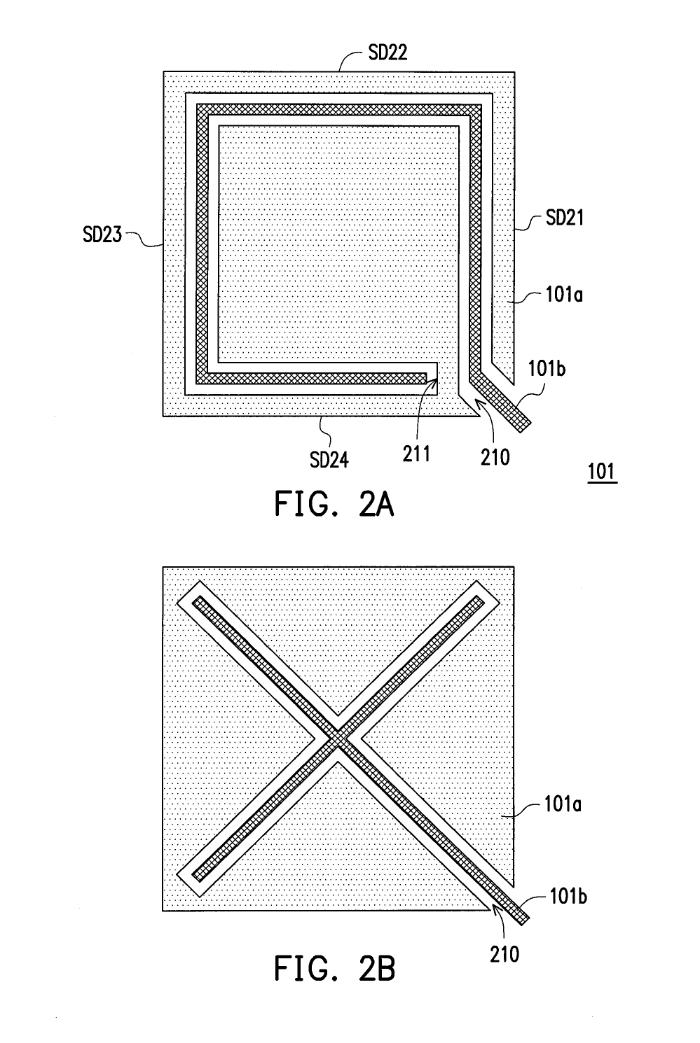

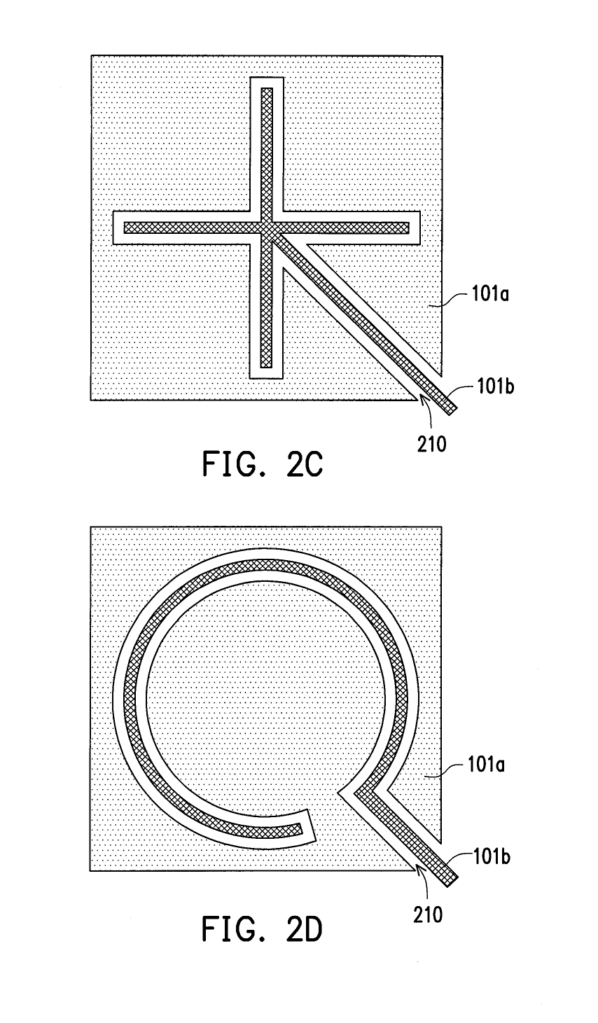

FIG. 2A is a diagram of a touch unit according to an embodiment of the present invention. In order to allow those having ordinary skill in the art to well understand the capacitive sensing structure provided by the present embodiment, the layout of the first electrode and the second electrode in each touch unit will be described below by taking the touch unit 101 illustrated in FIG. 2A as an example.

Referring to FIG. 2A, both the first electrode 101a and the second electrode 101b are disposed over the surface 11 of the substrate 10. The first electrode 101a is in a rectangular shape and has edges SD21-SD24. A patterned groove 210 is formed in the first electrode 101a. The patterned groove 210 penetrates the first electrode 101a along the edges SD21-SD24 of the first electrode 101a to form an opening. For example, in the embodiment illustrated in FIG. 2A, the opening of the patterned groove 210 is located at a corner of the first electrode 101a, and the patterned groove 210 penetrates the first electrode 101a sequentially along the directions parallel to the edges SD21-SD24.

The second electrode 101b is in a strip shape and has a plurality of bending structures. Besides, the second electrode 101b is extended from the opening of the patterned groove 210 towards a bottom 211 of the patterned groove 210 through the bending structures, and the second electrode 101b and the first electrode 101a are not electrically connected with each other. In other words, the second electrode 101b is disposed in the patterned groove 210 and extended out of the first electrode 101a from the opening of the patterned groove 210. Accordingly, most of the second electrode 101b is surrounded by the first electrode 101a. Besides, one end of the second electrode 101b is extended out of the first electrode 101a, and the other end of the second electrode 101b is extended into the first electrode 101a and is corresponding to the bottom 211 of the patterned groove 210.

It should be mentioned that even though the shapes of the patterned groove 210 and the second electrode 101b are mentioned in the embodiment illustrated in FIG. 2A, the present invention is not limited thereto, and those having ordinary skill in the art can determine the shapes of the patterned groove 210 and the second electrode 101b according to the actual design requirement. FIGS. 2B-2D are diagrams of a touch unit according to other embodiments of the present invention. As shown in FIG. 2B, the patterned groove 210 is in an X shape, and the second electrode 101b in the patterned groove 210 is also in an X shape. As shown in FIG. 2C, the patterned groove 210 and the second electrode 101b are both in a cross-like shape. As shown in FIG. 2D, the patterned groove 210 and the second electrode 101b are both in a ring-like shape. Similarly, the second electrode 101b can be disposed in the first electrode 101a through the patterned groove 210 in any geometrical shape.

Thereby, the first electrode 101a and the second electrode 101b in the touch unit 101 produce a corresponding sensing capacitance. Besides, the sensing capacitance changes with a user's touch, and each of the first electrode 101a and the second electrode 101b is capable of transmitting a signal to a corresponding processor. In other words, in a real application, a touch circuit can be formed by using a plurality of touch units. For example, as shown in FIG. 1, a touch circuit is formed by the touch units 101-104. The second electrodes 101b-104b in the touch units 101-104 are electrically connected to a node ND1, and the touch units 101-104 are arranged in an array and are rotationally symmetrical with respect to the node ND1.

It should be mentioned that in a real application, each of the first electrodes 101a-104a in the touch units 101-104 is equivalent to an independent sensor, and the second electrodes 101b-104b in the touch units 101-104 which are connected with each other are equivalent to an area sensor. Thus, when the capacitive sensing structure 100 is applied to a touch device, in the touch device, 4 sensing channels are disposed with respect to the 4 first electrodes 101a-104a, and only one sensing channel is disposed with respect to the second electrodes 101b-104b. In other words, because the second electrodes 101b-104b in the touch units 101-104 are electrically connected with each other, the amount of sensing channels in the capacitive touch device is reduced, and accordingly the circuit layout of the capacitive touch device is simplified.

Even though an implementation of a touch circuit has been described in the embodiment illustrated in FIG. 1, the present invention is not limited thereto, and those having ordinary skill in the art can change the number of touch units in the touch circuit according to the design requirement.

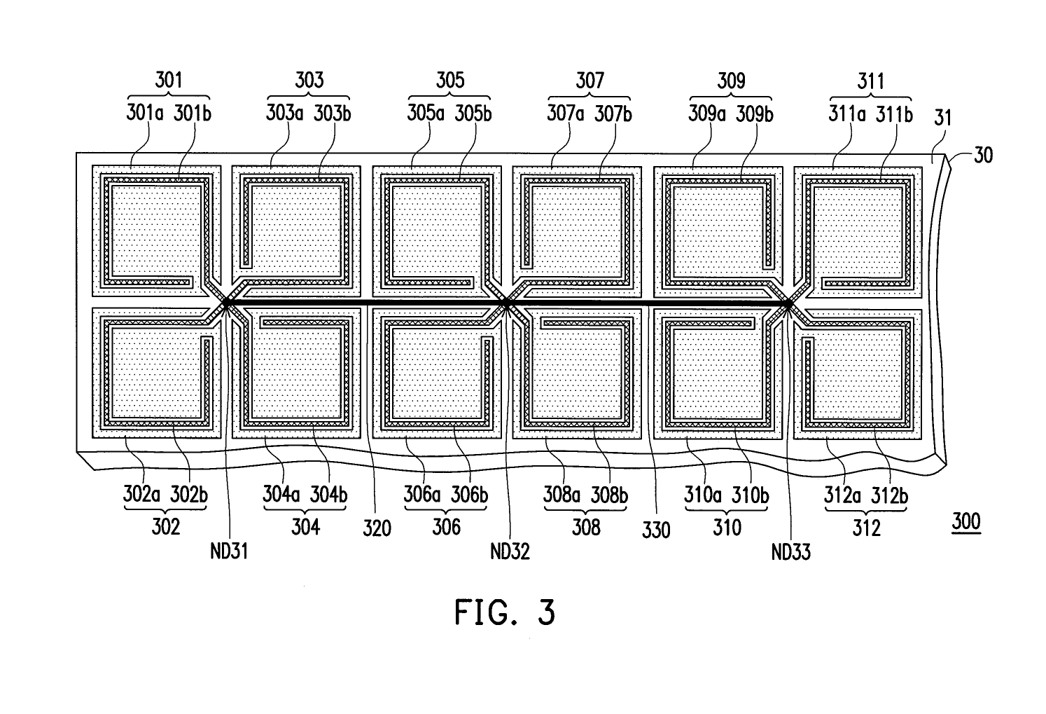

FIG. 3 is a diagram of a capacitive sensing structure according to another embodiment of the present invention. Referring to FIG. 3, the capacitive sensing structure 300 includes a substrate 30 and 12 touch units 301-312. The touch units 301-312 are disposed over a surface 31 of the substrate 30. Each touch unit includes a first electrode and a second electrode. In other words, in the embodiment illustrated in FIG. 3, the 12 touch units 301-312 include 12 first electrodes 301a-312a and 12 second electrodes 301b-312b.

In the embodiment illustrated in FIG. 3, a touch circuit is formed by 12 touch units 301-312. To be specific, in the touch circuit illustrated in FIG. 3, 4 touch units form a sub touch circuit, and accordingly 3 sub touch circuits are formed. For example, the touch units 301-304 form the first sub touch circuit, and the layout of the touch units 301-304 is the same as that of the touch units 101-104 in FIG. 1. Namely, the second electrodes 301b-304b in the touch units 301-304 are electrically connected to a node ND31, and the touch units 301-304 are rotationally symmetrical with respect to the node ND31.

Similarly, the touch units 305-308 form the second sub touch circuit, and the touch units 309-312 form the third sub touch circuit. Besides, the layouts of the touch units 305-308 and the touch units 309-312 are the same as that of the touch units 101-104 in FIG. 1. Namely, the second electrodes 305b-308b in the touch units 305-308 are electrically connected to a node ND32, and the touch units 305-308 are rotationally symmetrical with respect to the node ND32. Besides, the second electrodes 309b-312b in the touch units 309-312 are electrically connected to a node ND33, and the touch units 309-312 are rotationally symmetrical with respect to the node ND33. Additionally, to allow the second electrodes in the touch circuit to be electrically connected with each other, the capacitive sensing structure 300 further includes a first wire 320 and a second wire 330. The first wire 320 is electrically connected between the node ND31 and the node ND32, and the second wire 330 is electrically connected between the node ND32 and the node ND33.

Moreover, when the capacitive sensing structure 300 is applied to a touch device, in the touch device, 12 sensing channels are disposed with respect to the first electrodes 301a-312a, and only one sensing channel is disposed with respect to the second electrodes 301b-312b. In other words, because the second electrodes 301b-312b of the touch units 301-312 are electrically connected with each other, the amount of sensing channels in the capacitive touch device is reduced, and accordingly the circuit layout of the capacitive touch device is simplified.

Even though each of the capacitive sensing structures in the embodiments illustrated in FIG. 1 and FIG. 3 includes a single touch circuit, the present invention is not limited thereto, and those having ordinary skill in the art can change the number of touch circuits according to the design requirement.

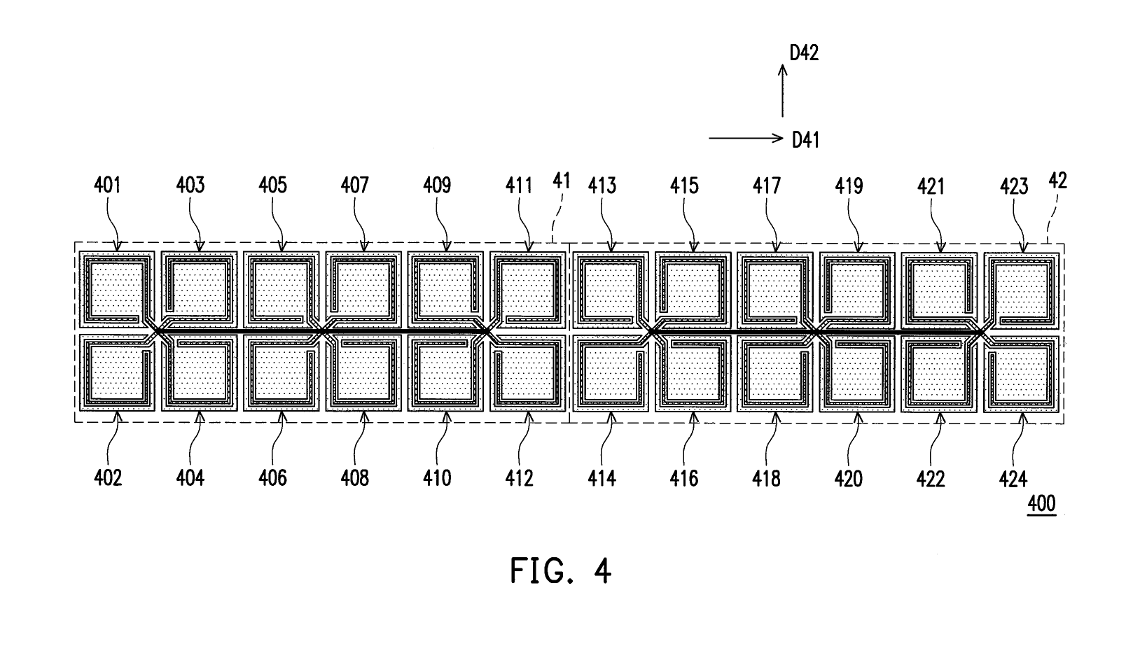

FIG. 4 is a diagram of a capacitive sensing structure according to yet another embodiment of the present invention. Referring to FIG. 4, the capacitive sensing structure 400 includes a substrate (not shown) and 24 touch units 401-424. The touch units 401-424 are sequentially arranged over a same surface of the substrate to form a single-layer electrode structure. Besides, in the capacitive sensing structure 400, every 12 touch units are grouped together to sequentially form 2 touch circuits 41 and 42.

To be specific, the touch units 401-412 form the first touch circuit 41, and the layout of the touch units 401-412 in the first touch circuit 41 is the same as that of the touch units 301-312 in FIG. 3. Similarly, the touch units 413-424 form the second touch circuit 42, and the layout of the touch units 401-412 in the second touch circuit 42 is the same as that of the touch units 301-312 in FIG. 3. In addition, the first touch circuit 41 and the second touch circuit 42 are sequentially arranged along a first direction 41, and the first touch circuit 41 and the second touch circuit 42 are symmetrical with respect to a second direction 42 perpendicular to the first direction 41.

It should be noted that similar to that in the embodiment illustrated in FIG. 3, second electrodes in the first touch circuit 41 are electrically connected with each other, and the second electrodes in the second touch circuit 42 are electrically connected with each other. Besides, the first electrodes in two corresponding touch units of the two touch circuits 41 and 42 are also electrically connected with each other. For example, if the 24 touch units 401-424 are sequentially regarded as a 1^{st} touch unit 401 to a 24^{th} touch unit 424, the first electrode in the 1^{st} touch unit 401 is electrically connected to the first electrode in the 13^{th} touch unit 413, the first electrode in the touch unit 402 is electrically connected to the first electrode in the 14^{th} touch unit 414, the first electrode in the 3^{rd} touch unit 403 is electrically connected to the first electrode in the 15^{th} touch unit 415, . . . , and the first electrode in the i^{th} touch unit is electrically connected to the first electrode in the (i+12)^{th} touch unit, where i is an integer and 1≦i≦12.

In a real application, the first touch circuit 41 is corresponding to a first sensing area, and the second touch circuit 42 is corresponding to a second sensing area. The first sensing area and the second sensing area are occupied mainly by the first electrodes in the touch units 401-424. Thus, each first electrode in the touch units 401-424 is equivalent to an independent sensor. Additionally, because the first electrodes in the two corresponding touch units of the two touch circuits 41 and 42 are electrically connected with each other, the two independent sensors at corresponding positions in the two touch circuits 41 and 42 can share the same sensing channel. In other words, when the capacitive sensing structure 400 is applied to a touch device, 12 sensing channels can be disposed with respect to the 24 first electrodes in the touch device.

Moreover, the second electrodes in the first touch circuit 41 are equivalent to an area sensor, and the second electrodes in the second touch circuit 42 are equivalent to another area sensor. Thus, in a touch device, 2 sensing channels can be disposed with respect to the 24 second electrodes. In other words, because the second electrodes in the touch circuits are electrically connected and the first electrodes in two corresponding touch units of the two touch circuits are also electrically connected, the amount of sensing channels in a capacitive touch device is reduced, and accordingly the circuit layout of the capacitive touch device is simplified.

Furthermore, in a single-touch case, when a touch unit (for example, the touch unit 401) is pressed, the first electrode in the touch unit 401 contributes a corresponding sensing capacitance C11, and the first electrode in the touch unit 413 which shares the same sensing channel with the touch unit 401 also contributes a corresponding sensing capacitance C12. Besides, the second electrodes in the first touch circuit 41 contribute a corresponding area capacitance CG1. Thus, when the touch unit 401 is pressed, C11+CG1≠C12. Similarly, when the touch unit 413 is pressed, the first electrode in the touch unit 401 contributes a corresponding sensing capacitance C11, and the first electrode in the touch unit 413 contributes a corresponding sensing capacitance C12. Besides, the second electrodes in the second touch circuit 42 contribute a corresponding area capacitance CG2. Thus, when the touch unit 402 is pressed, C12+CG2≠C11. In other words, the area capacitances CG1 and CG2 contributed by the second electrodes can be used for identifying a sensing area.

In a multi-touch case, when two touch units (for example, the touch units 401 and 413) are pressed at the same time, C11+CG1+C12≈C12+CG2+C11. In other words, the sensing results of the two touch points are the same, which means the multi-touch condition is satisfied. It should be mentioned that the first electrodes in the two corresponding touch units of the two touch circuits 41 and 42 share the same sensing channel. Therefore, when two touch units whose first electrodes share the same sensing channel are pressed at the same time, the touch points are identified by using a multi-touch technique. Contrarily, when two touch units whose first electrodes are not electrically connected (for example, the touch units 401 and 418) are pressed at the same time, the touch points are still identified by using a single-touch technique.

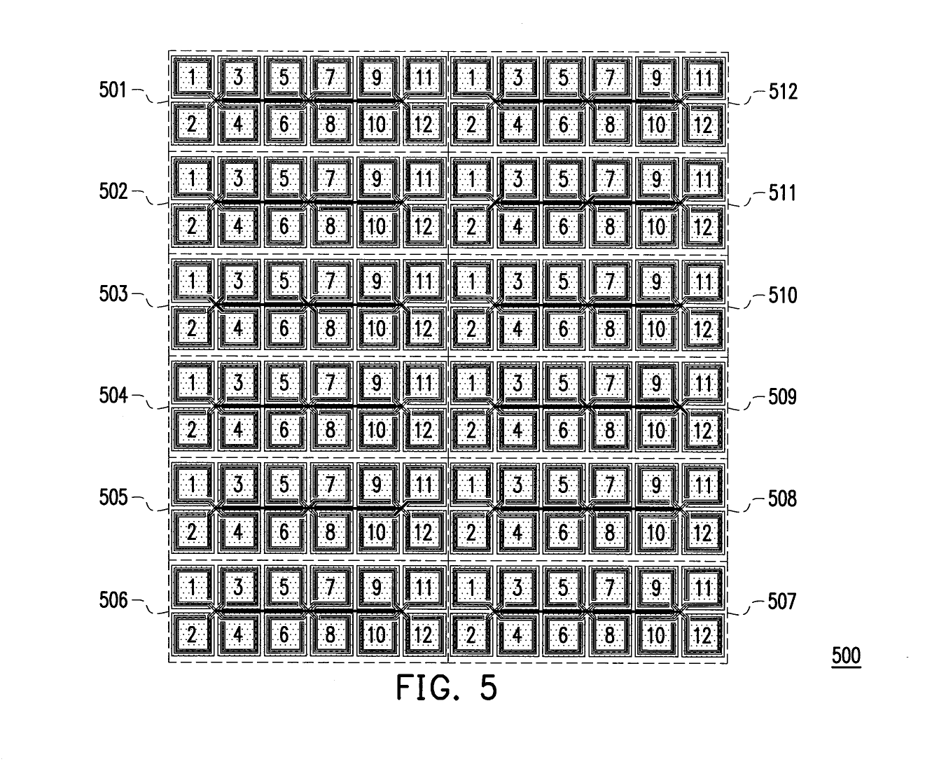

In another embodiment of the present invention, the capacitive sensing structure may include more than two touch circuits. FIG. 5 is a diagram of a capacitive sensing structure according to still another embodiment of the present invention. Referring to FIG. 5, the capacitive sensing structure 500 includes a substrate (not shown) and 12 touch circuits 501-512. Each of the touch circuits 501-512 has a same layout as that of the touch circuit 41 in the embodiment illustrated in FIG. 4. Namely, the touch circuits 501-512 respectively include 12 first electrodes and 12 second electrodes so as to form 12 touch units in each of the touch circuits 501-512. Besides, the 12 second electrodes in each of the touch circuits 501-512 are electrically connected with each other. For the convenience of description, the 12 first electrodes in each of the touch circuits 501-512 are respectively marked with reference numbers 1-12.

It should be noted that the first electrodes at corresponding positions in the touch circuits 501-512 are electrically connected with each other. For example, in the touch circuits 501-512, the first electrodes 1 are electrically connected with each other, the first electrodes 2 are electrically connected with each other, and so on. In other words, in the embodiment illustrated in FIG. 5, the first electrodes having the same reference number are electrically connected with each other. Accordingly, when the capacitive sensing structure 500 is applied to a touch device, 12 sensing channels are disposed with respect to 144 first electrodes in the touch device. In addition, because the second electrodes in each touch circuit are electrically connected, 12 sensing channels are disposed with respect to 144 second electrodes in the touch device. In other words, because the second electrodes in each touch circuit are electrically connected and the corresponding first electrodes in the touch circuits are also electrically connected, the amount of sensing channels in a capacitive touch device is reduced, and accordingly the circuit layout of the capacitive touch device is simplified.

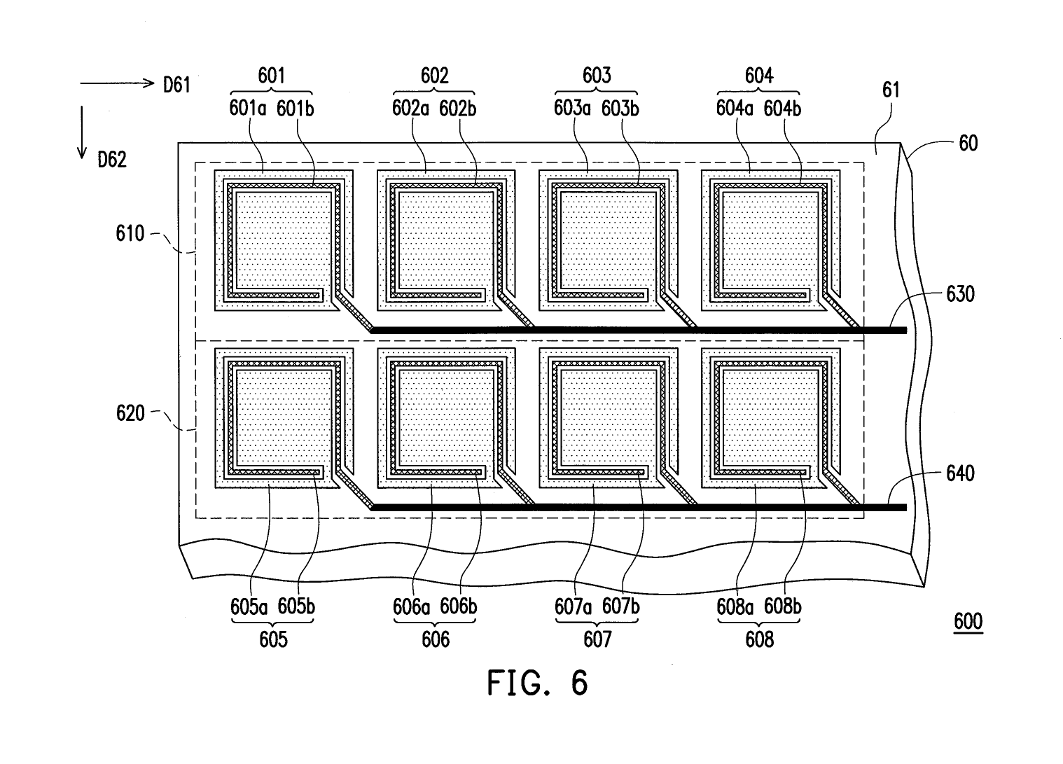

FIG. 6 is a diagram of a capacitive sensing structure according to yet still another embodiment of the present invention. Referring to FIG. 6, the capacitive sensing structure 600 includes a substrate 60 and touch units 601-608. The touch units 601-608 are disposed over a surface 61 of the substrate 60. Each touch unit includes a first electrode and a second electrode. For example, the touch unit 601 includes a first electrode 601a and a second electrode 601b, and the touch unit 602 includes a first electrode 602a and a second electrode 602b. Similarly, the touch units 603-608 of the capacitive sensing structure 600 include first electrodes 603a-608a and second electrodes 603b-608b. In addition, the layout of each touch unit is the same as that of the touch unit 101 illustrated in FIG. 2A.

It should be noted that in the capacitive sensing structure 600, every 4 touch units are grouped together to form two touch circuits 610 and 620 sequentially. The 4 touch units 601-604 in the touch circuit 610 are sequentially arranged along a first direction D61, and the second electrodes 601b-604b in the 4 touch units 601-604 are electrically connected to a first wire 630. Similarly, the 4 touch units 605-608 in the touch circuit 620 are sequentially arranged along the first direction D61, and the second electrodes 605b-608b in the 4 touch units 605-608 are electrically connected to a second wire 640. In addition, the touch circuits 610 and 620 are sequentially arranged along a second direction D62 perpendicular to the first direction D61.

The first electrodes at the corresponding positions in the touch circuits 610-620 are electrically connected with each other. For example, the first electrode 601a in the touch circuit 610 is electrically connected to the first electrode 605a in the touch circuit 620, and the first electrode 602a in the touch circuit 610 is electrically connected to the first electrode 606a in the touch circuit 620. Similarly, the first electrodes 603a-604a are electrically connected to the first electrodes 607a-608a respectively. Thus, the capacitive sensing structure 600 can simplify the circuit layout of a capacitive touch device. The capacitive sensing structure 600 can be applied to a touch keyboard.

As described above, the touch units in a capacitive sensing structure provided by the present invention have a single-layer electrode structure. Besides, according to the present invention, the second electrodes in each touch circuit are electrically connected, and the first electrodes at the corresponding positions in the touch circuits are also electrically connected. Thereby, the capacitive sensing structure provided by the present invention can reduce the amount of sensing channels in a capacitive touch device and accordingly simplify the circuit layout of the capacitive touch device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A capacitive sensing structure, comprising:
a substrate; and
a plurality of touch units, wherein each of the touch units comprises:
a first electrode, disposed over a surface of the substrate, wherein a patterned groove is formed in the first electrode, and the patterned groove penetrates the first electrode to form an opening; and
a second electrode, disposed in the patterned groove, and extended out of the first electrode from the opening of the patterned groove, wherein the first electrode is electrically disconnected from the second electrode.

2. The capacitive sensing structure according to claim 1 further comprising:
a first touch circuit, formed by a 1^{st} touch unit to an N^{th} touch unit among the touch units, wherein the second electrodes in the 1^{st} touch unit to the N^{th} touch unit are electrically connected, and N is a positive integer.

3. The capacitive sensing structure according to claim 2 further comprising:
a second touch circuit, formed by a (N+1)^{th} touch unit to a 2N^{th} touch unit among the touch units, wherein the second electrodes in the (N+1)^{th} touch unit to the 2N^{th} touch unit are electrically connected, the first electrode in the i^{th} touch unit is electrically connected to the first electrode in the (i+N)^{th} touch unit, i is an integer, and

4. The capacitive sensing structure according to claim 3, wherein the first touch circuit and the second touch circuit are sequentially arranged along a first direction, and the first touch circuit and the second touch circuit are symmetrical with respect to a second direction perpendicular to the first direction.

5. The capacitive sensing structure according to claim 3, wherein the 1^{st} touch unit to the N^{th} touch unit in the first touch circuit are sequentially arranged along a first direction, the (N+1)^{th} touch unit to the 2N^{th} touch unit in the second touch circuit are sequentially arranged along the first direction, and the first touch circuit and the second touch circuit are sequentially arranged along a second direction perpendicular to the first direction.

6. The capacitive sensing structure according to claim 2, wherein the second electrodes in the 1^{st} touch unit to the N^{th} touch unit are electrically connected to a node, and the 1^{st} touch unit to the N^{th} touch unit are arranged in an array and are rotationally symmetrical with respect to the node.

7. The capacitive sensing structure according to claim 2, wherein N=3*M, M is a positive integer, and the second electrodes in the 1^{st} touch unit to the M^{th} touch unit are electrically connected to a first node, the second electrodes in the (M+1)^{th} touch unit to the 2*M^{th} touch unit are electrically connected to a second node, the second electrodes in the (2*M+1)^{th} touch unit to the 3*M^{th} touch unit are electrically connected to a third node, the first node is electrically connected to the second node through a first wire, and the second node is electrically connected to the third node through a second wire.

8. The capacitive sensing structure according to claim 7, wherein the 1^{st} touch unit to the 3*M^{th} touch unit are arranged in an array, the 1^{st} touch unit to the M^{th} touch unit are rotationally symmetrical with respect to the first node, the (M+1)^{th} touch unit to the 2*M^{th} touch unit are rotationally symmetrical with respect to the second node, and the (2*M+1)^{th} touch unit to the 3*M^{th} touch unit are rotationally symmetrical with respect to the third node.

9. A capacitive sensing structure, comprising:
a substrate; and
a plurality of touch units, wherein each of the touch units comprises:
a first electrode, disposed over a surface of the substrate, wherein a groove is formed penetrating the first electrode; and
a second electrode, disposed in the groove, wherein the first electrode is electrically disconnected from the second electrode,
wherein the first electrode and the second electrode are each capable of transmitting a signal to a corresponding processor.
